(19) United States
(12) Patent Application Publication
(10) Pub. No.: US 2023/0203243 A1
(43) Pub. Date: Jun. 29, 2023

(54) A METHOD FOR MANUFACTURING AN OLIGOMERIC POLYETHYLENE TEREPHTHALATE (PET) SUBSTRATE

(71) Applicant: Koch Technology Solutions, LLC, Wichita, KS (US)

(72) Inventors: Clive Alexander HAMILTON, North Yorkshire (GB); George Malcolm WILLIAMSON, Wilmington, NC (US)

(73) Assignee: Koch Technology Solutions, LLC, Wichita, KS (US)

(21) Appl. No.: 17/927,364

(22) PCT Filed: Jun. 2, 2021
(86) PCT No.: PCT/IB2021/054842

§ 371 Date: Nov. 23, 2022

Related U.S. Application Data
(60) Provisional application No. 63/035,182, filed on Jun. 5, 2020.

(51) Int. Cl. C08G 63/183; C08G 63/82

(52) U.S. Cl. CPC C08G 63/183; C08G 63/826

(57) ABSTRACT

A method for producing an oligomeric PET substrate for use in a rPET manufacturing process comprises reacting recycled bis-hydroxylethyleneterephthalate (rBHET) or a higher molecular weight oligomer derived from rBHET, with PTA to produce an oligomeric PET substrate represented by Formula (I), wherein R₁ is a carboxyl end group or a hydroxyl end group, R₂ is a carboxyl end group or a hydroxyl end group, and n is a degree of polymerisation.

### CROSS-REFERENCE TO RELATED APPLICATIONS

This application claims the benefit of U.S. Provisional Application No. 63/035,182, filed Jun. 5, 2020, the disclosure of which is incorporated herein by reference in its entirety.

### FIELD

The present disclosure relates to a method for manufacturing an oligomeric PET substrate from recycled bis-hydroxylethyleneterephthalate (rBHET), an oligomeric PET substrate for use in manufacturing recycled PET polymer and also PET polymer made from 5-100% recycled PET, produced from the oligomeric PET substrate.

### BACKGROUND

PET (polyethylene terephthalate) is a synthetic material that was first made in the mid-1940s. PET has desirable properties and processing abilities and hence is now used extensively on a global scale for packaging applications in the food and beverage industries and for industrial products, as well as in the textile industry.

Typically, PET has petrochemical origins. Purified terephthalic acid is first formed via aerobic catalytic oxidation of p-xylene in acetic acid medium in a purified terephthalic acid manufacturing facility. This purified terephthalic acid (PTA) is subsequently reacted with ethylene glycol to produce a PTA-based oligomer (and water), which polycondenses to form PET polymer. An alternative route to PET polymer is via polymerisation of a bis-hydroxylethyleneterephthalate (BHET) monomer, although this route is less favorable from a process economics point of view. The BHET monomer is formed through the reaction of dimethylterephthalate (DMT) (a diester formed from terephthalic acid and methanol) with ethylene glycol, and then the BHET monomer polymerises with itself to form longer chains of PET.

In a typical PET manufacturing process, there are three main stages in the melt-phase process to make the PET polymer: (1) esterification, (2) pre-polymerisation, and (3) polymerisation. When making PET resin, the PET polymer enters a further solid-state polymerisation (SSP) stage to make further changes which include increasing the molecular weight of the polymer. In the initial esterification stage, the PTA (or DMT) and ethylene glycol are mixed and fed into an esterification unit, where esterification, which may be catalysed or uncatalyzed, takes place under atmospheric pressure and a temperature in the range of 270° C. to 295° C. Water (or methanol in the case of DMT) resulting from the esterification reaction and excess ethylene glycol are vaporised. Additives, including catalysts, toners etc., are typically added to the process in between the esterification stage and the subsequent pre-polymerisation stage. In the pre-polymerisation stage, the product from the esterification unit is sent to the pre-polymerisation unit and reacted with extra ethylene glycol at a temperature in the range of 270° C. to 295° C. under significantly reduced pressure to allow the degree of polymerisation of the oligomer to increase. During the polymerisation stage, the product from the pre-polymerisation stage is again subjected to low pressures and a temperature in the range of 270° C. to 295° C. in a horizontal polymerisation unit, typically known as the Finisher, to further allow an increase in the degree of polymerisation to approximately 80-120 repeat units. When making PET resin, a fourth, solid-state polymerisation (SSP) stage is usually required involving a crystallisation step wherein the amorphous pellets produced in the melt phase process are converted to crystalline pellets, which are then subsequently processed further depending on the final PET product, which may be as diverse as containers/bottles for liquids and foods, or industrial products and resins.

It is desirable to recycle post-consumer PET-containing waste material to reduce the amount of plastic sent to landfill. One known recycling method is to take post-consumer PET-containing waste material, such as PET plastic bottles, and mechanically break it up to produce post-consumer recycled (PCR) flake. This PCR flake may be glycolysed to convert it to recycled bis-hydroxylethyleneterephthalate (rBHET). This rBHET can then be used in a PET manufacturing process to make recycled PET (rPET; so-called because the oligomer upon which it is based is derived from post-consumer PET or PCR, rather than PTA or DMT). This circumvents the need to use more PTA with petrochemical origins, in combination with ethylene glycol, to make a PTA-based oligomer in a virgin PTA (vPTA) process or to make virgin BHET (vBHET) in a virgin DMT (vDMT) process. In addition, since lower amounts of petrochemicals are required to make recycled PET (rPET) as compared to new PET, known as virgin PET (vPET), rPET consequently has a lower carbon footprint than vPET. Therefore, rPET is attractive based on its ‘green’ credentials, which themselves may confer economic benefits in certain jurisdictions.

However, rPET made from rBHET tends to have lower reactivity in the melt phase process and in the solid phase polymerisation stage. If rBHET is used in a PET manufacturing process, the amount of rPET manufactured is approximately 20% lower than if a PTA-based oligomer is used (i.e. short-chain PET oligomers made through esterification of purified terephthalic acid with ethylene glycol). Further still, rPET made from rBHET tends to be darker (lower L*) and more yellow, which is mainly due to impurities present in the rPET polymer. At present, therefore, rPET manufacturing processes using rBHET (glycolysis product of PET waste) are neither attractive nor competitive when compared with vPET processes using a PTA-based oligomer or vBHET.

Therefore, there exists a need to produce an oligomeric PET substrate which has an increased reactivity and consequently increased ability to polymerise to form rPET in order to compete with processes making vPET.

### SUMMARY OF INVENTION

The present disclosure provides, inter alia, a method for producing an oligomeric PET substrate for use in a rPET manufacturing process, comprising reacting rBHET or a higher molecular weight oligomer derived from rBH ET with PTA to produce an oligomeric PET substrate represented by Formula I:

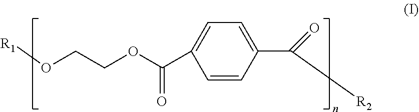

wherein R1 is a carboxyl end group or a hydroxyl end group, R2 is a carboxyl end group or a hydroxyl end group, and n is a degree of polymerisation.

In some embodiments, when the method comprises reacting rBHET with PTA, n is 1 to 10, preferably 3 to 7. In some embodiments, when the method comprises reacting a higher molecular weight oligomer derived from rBHET with PTA, n is 20 to 50, preferably 25 to 35. In some embodiments, when the method comprises reacting rBHET with PTA, the oligomeric PET substrate has a CEG (mols acid ends/te of material) of from 300 to 1500, preferably from 500 to 1200, more preferably from 700 to 1100. In some embodiments, when the method comprises reacting a higher molecular weight oligomer derived from rBHET with PTA, the oligomeric PET substrate has a CEG (mols acid ends/te of material) of from 40 to 200, preferably from 80 to 150. In some embodiments, the oligomeric PET substrate has a hydroxyl end group: carboxyl end group ratio in the range of 1.66 to 6.66, preferably in the range of 2.22 to 4.0.

In some embodiments, when the method comprises reacting rBHET with PTA, the PTA is added to the rBHET in an amount in the range from 10 wt % to 60 wt %, preferably from 30 wt % to 36 wt % with respect to PET polymer. In some embodiments, when the method comprises reacting a higher molecular weight oligomer derived from rBHET with PTA, the PTA is added to the rBHET in an amount in the range from 0.5 wt % to 5 wt %, preferably from 1 wt % to 2 wt % with respect to PET polymer. In some embodiments, the rBHET or a higher molecular weight oligomer derived from rBHET is mixed with said PTA prior to addition to a reaction zone. In some embodiments, the rBHET is reacted with said PTA at a temperature from 120° C. to 300° C., preferably from 150° C. to 270° C. In some embodiments, higher molecular weight oligomer derived from rBHET is reacted with PTA at a temperature from 270° C. to 300° C., preferably from 285° C. to 295° C. In some embodiments, the method comprises a residence time in a reaction zone of from 30 minutes to 120 minutes, preferably from 40 minutes to 50 minutes. In some embodiments, the rBHET or higher molecular weight oligomer derived from rBHET is reacted with said PTA at a pressure between 3 barg and 30 barg.

In some embodiments, the rBHET or higher molecular weight oligomer derived from rBHET is reacted with said PTA using an exogenously added catalyst selected from an antimony-containing catalyst, titanium-containing catalyst, a zinc-containing catalyst, an acetate-containing catalyst, a manganese-containing catalyst, a germanium-containing catalyst, an aluminium-containing catalyst, a tin-containing catalyst and mixtures thereof. In some embodiments, the catalyst is any one of antimony trioxide, antimony glycolate, antimony triacetate, titanium alkoxide, zinc acetate or manganese acetate. In some embodiments, the oligomeric PET substrate is fed directly or indirectly into a rPET manufacturing process.

The disclosure also provides an oligomeric PET substrate produced by the methods described herein, wherein said oligomeric PET substrate is represented by Formula I:

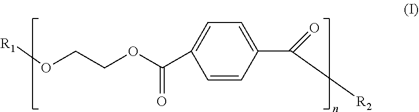

R1 being a carboxyl end group or a hydroxyl end group, R2 being a carboxyl end group or a hydroxyl end group, and n being a degree of polymerisation, wherein said oligomeric PET substrate is represented by any two of the following characteristics: i) n is 1-10 or 20 to 50; ii) a CEG (mols acid ends/metric ton (te) of material) of from 300 to 1500 or 40 to 200; or iii) a carboxyl end group/hydroxyl end group ratio in the range of 1.66 to 6.66. In some embodiments, the oligomeric PET substrate is used in synthesis of a polymer comprising 5-100% rPET.

The present disclosure also provides a PET polymer made from 5-100% rPET, produced from the oligomeric PET substrate as represented by Formula I.

### BRIEF DESCRIPTION OF THE FIGURES

FIG. 1 is a schematic diagram illustrating a method in accordance with one aspect of the disclosure where rBHET and PTA are reacted to produce an oligomeric PET substrate.

FIG. 2 is a flowsheet schematic according to the process disclosed herein showing the location where PTA powder can be added later in the process to the oligomer exiting the pre-polymerisation vessel (UFPP).

FIG. 3 is an alternative flowsheet schematic according to the process disclosed herein showing the location where PTA powder can be added later in the process to the oligomer exiting the pre-polymerisation vessel (UFPP).

FIG. 4 is a graph illustrating finisher pressure as a function of the oligomer OH:COOH ratio in accordance with the simulated process of producing PET described in Comparative Example 5.

FIG. 5 is a graph illustrating plant rate as a function of the oligomer OH:COOH ratio in accordance with the simulated process of producing PET described in Comparative Example 5.

FIG. 6 is a graph illustrating finisher pressure against the oligomer OH:COOH in accordance with the simulated process of producing PET described in Example 7.

FIG. 7 is a graph illustrating finisher vacuum requirement against the oligomer OH:COOH in accordance with the simulated process of producing PET described in Example 7.

### DETAILED DESCRIPTION

Disclosed herein are methods to produce an oligomeric PET substrate from rBHET or a higher molecular weight oligomer derived from rBHET, an oligomeric PET substrate for use in manufacturing rPET, and PET polymer made from 5-100% rPET, which comprises the oligomeric PET substrate. In the methods described herein, rBHET or a higher molecular weight oligomer derived from rBHET is reacted with PTA to produce the oligomeric PET substrate.

The methods disclosed herein address a problem recognized in the art with respect to the lower reactivity of rBHET as compared to vBHET in the manufacturing of PET oligomers and the consequentially lower yields of PET oligomers prepared from rBHET as compared to PET oligomers prepared from vBHET or PTA. In particular, the disclosure provides a means to improve the efficiency of rPET manufacturing by reacting BHET or a higher molecular weight oligomer derived from BHET with PTA at specific points in the manufacturing process. These methods increase the ability of practitioners to prepare PET from recycled starting materials in a manner that is economically competitive with methods for preparing virgin PET.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. In case of conflict, the present specification, including definitions, will control.

In addition, the materials, methods, and examples are illustrative only and not intended to be limiting. The details of one or more embodiments of the invention are set forth in the accompanying drawings and the description below. Other features, objects, and advantages of the invention will be apparent from the description and the drawings, and from the claims. The word “comprising” in the claims may be replaced by “consisting essentially of” or with “consisting of,” according to standard practice in patent law.

Unless specifically stated otherwise or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The term “PET” or “PET polymer” refers to polyethylene terephthalate.

The term “PTA” refers to purified terephthalic acid.

The term “vPTA” refers to PTA synthesised via aerobic catalytic oxidation of p-xylene in acetic acid medium.

As used herein, “PTA-based oligomer” refers to a short-chain PET oligomer synthesised through a process requiring esterification of purified terephthalic acid with ethylene glycol. Purified terephthalic acid (PTA) is reacted with ethylene glycol to produce the PTA-based oligomer (and water), which polycondenses to form PET polymer. When PTA is reacted with ethylene glycol, a short chain PTA-based oligomer is formed which is characterised by a Dp (degree of polymerisation or number of repeat units) and a CEG (or carboxyl acid end group concentration). The degree of polymerisation (Dp) is calculated from the number average molecular weight Mn by the following formula: Dp=(Mn−62)/192, in which Mn is calculated by rearranging the following correlation to IV (intrinsic viscosity): IV=1.7e−4 (Mn)^{0.83}. The intrinsic viscosity (IV) of the polyester can be measured by a melt viscosity technique equivalent to ASTM D4603-96. Typically, for a PTA-based oligomer formed by reacting PTA with ethylene glycol, the degree of polymerisation is usually between 3 and 7 and the CEG is usually between 500 and 1200 (mols acid ends/to of material). The hydrooxyl end group (HEG)/carboxyl end group (CEG) ratio is determined from the CEG measurement and the rearrangement of following calculation of Mn: Mn=2e6/(CEG+HEG).

As used herein “PET manufacturing process” refers to a facility that produces PET. Such a facility may be integrated with a PTA manufacturing process or may be entirely independent.

As used herein, “post-consumer PET-containing waste material” refers to any waste stream that contains at least 10% PET waste. The post-consumer PET-containing waste material may therefore comprise 10% to 100% PET. The post-consumer PET-containing waste material may be municipal waste which itself includes at least 10% PET waste, such as PET plastic bottles or PET food packaging or any consumer recycled PET-containing waste material such as waste polyester fibre. Waste polyester fibre sources include items such as clothing items (shirts, trousers, dresses, coats etc.), bed linen, duvet linings or towels. The “post-consumer PET-containing waste material” may further comprise post-consumer recycled (PCR) flake, which is waste PET plastic bottles which have been mechanically broken into small pieces in order to be used in a recycling process.

As used herein, “vPET” refers to virgin PET, which is PET synthesised through a process requiring esterification of purified terephthalic acid with ethylene glycol. The purified terephthalic acid (PTA) is reacted with ethylene glycol to produce a PTA-based oligomer (and water), which polycondenses to form PET polymer. Alternatively, vPET may be formed through the reaction of dimethylterephthalate (DMT) (a diester formed from terephthalic acid and methanol) with ethylene glycol. A BHET monomer is formed through the reaction of dimethylterephthalate (DMT) (a diester formed from terephthalic acid and methanol) with ethylene glycol, and then the BHET monomer polymerises with itself to form longer chains of PET.

As used herein, “rPET” refers to recycled PET, which is PET manufactured entirely or at least partially from oligomers that have been derived from post-consumer PET-containing waste material. The rPET may be synthesised from oligomers that are 100% derived from a post-consumer PET-containing waste material. Alternatively, the rPET may be synthesised from a combination of oligomers which include those derived from post-consumer PET-containing waste material and also those from vBHET or PTA-based oligomers used to make vPET. In one non-limiting embodiment, the rPET comprises at least 5% oligomeric PET substrate derived from post-consumer PET-containing waste material. In another non-limiting embodiment, the rPET comprises at least 50% oligomeric PET substrate derived from post-consumer PET-containing waste material. In yet another non-limiting embodiment, the rPET comprises at least 80% oligomeric PET substrate derived from post-consumer PET-containing waste material.

As used herein, “rPET manufacturing process” refers to both manufacturing processes and facilities that have been designed and built from scratch to synthesise recycled PET (rPET), namely PET from substrates that include those derived from any post-consumer PET-containing waste material in addition to virgin substrates (i.e. vBHET or PTA-based oligomer), and also manufacturing processes and facilities that were built to synthesise vPET but which have been modified or retrofitted to allow the production of rPET. Changes that are required to a vPET facility in order to produce rPET are typically not major structurally but instead require a number of process changes.

The term “BHET” refers to the bis-hydroxylethyleneterephthalate monomer (C12H14O6), including all structural isomers, which is characterised as having no carboxyl end groups, namely a carboxyl acid end group concentration (CEG) of zero. The chemical structure of the para-isomer of the BHET monomer is:

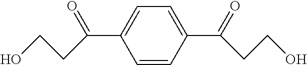 [SMILES: O=C(CCO)c1ccc(C(=O)CCO)cc1]

BHET reacts with itself to make longer chains in a polycondensation reaction, thereby forming polyethylene terephthalate and liberating ethylene glycol in the process. BHET, namely the BHET monomer, is typically formed through the reaction of dimethylterephthalate (DMT) with ethylene glycol but it is also a minor component of the oligomer made from PTA plus ethylene glycol, i.e. part of the oligomeric molecular weight distribution.

The term “vBHET” refers to virgin BHET, which is the BHET monomer formed through reaction of dimethylterephthalate (DMT) with ethylene glycol.

The term “rBHET” refers to recycled BHET, which is the BHET molecule produced by glycolyzing PET. Post-consumer PET-containing waste material, such as PET plastic bottles, is mechanically broken down to produce post-consumer recycled (PCR) flake. This PCR flake is then glycolysed to convert it to rBHET.

As used herein, “oligomeric PET substrate” refers to a molecule according to Formula I:

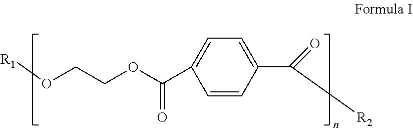

Either end of Formula I may be a carboxyl end group or a hydroxyl end group. Therefore, either R1 or R2 may be a carboxyl end group or a hydroxyl end group. The optimum ratio of hydroxyl end group:carboxyl end group in the oligomeric PET substrate is typically from 2.22 to 4.0. Formula I polymerises with itself in an esterification reaction, in which carboxyl end groups react with hydroxyl end groups to form an ester link, liberating water. The “n” represents the degree of polymerisation (Dp) or number of repeat units of Formula I that exist in the oligomeric PET substrate and may, for example, be from 3 to 7 or from 25 to 35. In addition to being characterised by the degree of polymerisation (Dp), the oligomeric PET substrate is also characterised by its carboxyl acid end group concentration, referred to herein as CEG. The CEG (units being mols acid ends/to of material) may, for example, be from 500 to 1200 or from 80 to 150.

Conventional approaches to produce rPET have typically used the process of glycolyzing PET (or waste sources comprising PET) using for example, ethylene glycol, to produce bis-hydroxylethyleneterephthalate (rBHET). The rBHET is then polymerised to produce rPET. However, this rBHET has a lower reactivity as compared to a PTA-based oligomer formed through an esterification reaction of purified terephthalic acid with ethylene glycol. Therefore, when used to make rPET, the rBHET yields approximately 20% less the amount of rPET as compared to the amount of vPET made using a PTA-based oligomer (formed through an esterification reaction of purified terephthalic acid with ethylene glycol), for comparable processes.

In accordance with the present disclosure, it has now been found that PTA can be reacted with rBHET or a higher molecular weight oligomer derived from rBHET to produce an oligomeric PET substrate having an increased reactivity as compared to unmodified rBHET. Therefore, an aspect of the present disclosure relates to a method for producing an oligomeric PET substrate by reacting rBHET or a higher molecular weight oligomer derived from rBHET with PTA.

In an embodiment, the rBHET is in powder or molten form and the PTA is in powder form.

In an embodiment of the present disclosure, there is provided an oligomeric PET substrate represented by Formula I:

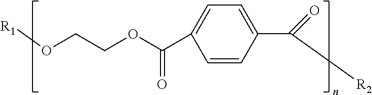

Either end of Formula I may be a carboxyl end group or a hydroxyl end group. Therefore, either R1 or R2 may be a carboxyl end group or a hydroxyl end group. Formula I has an optimum ratio of hydroxyl end group:carboxyl end group of typically from 1.66 to 6.66, and preferably from 2.22 to 4.0. The degree of polymerisation (Dp) or number of repeat units that exist in the oligomeric PET substrate may vary depending on whether rBHET or a higher molecular weight oligomer derived from rBHET is reacted with PTA to prepare the PET substrate. When rBHET is reacted with PTA, the degree of polymerisation (Dp) may be from 1 to 10, more typically from 3 to 7, and preferably 6. When a higher molecular weight oligomer derived from rBHET is reacted with PTA, the degree of polymerisation (Dp) may be from 20 to 50, and preferably from 25 to 35. In addition to being characterised by the degree of polymerisation (Dp) and the ratio of hydroxyl end group:carboxyl end group, the oligomeric PET substrate is also characterised by its carboxyl acid end group concentration, referred to herein as CEG. The CEG (units being mols acid ends/to of material) may vary depending on whether rBHET or a higher molecular weight oligomer derived from rBHET is reacted with PTA to prepare the PET substrate. When rBHET is reacted with PTA, the CEG may typically be from 300 to 1500, and preferably from 500 to 1200 or even from 700 to 1100. When a higher molecular weight rBHET oligomer is reacted with PTA, the CEG may be from 40 to 200, and preferably from 80 to 150.

In one non-limiting embodiment, the oligomeric PET substrate comprises a hydroxyl end group:carboxyl end group ratio of from 2.22 to 4.0, a Dp of from 4 to 7, and a CEG of from 700 to 1100 mols acid ends/te of material.

In another non-limiting embodiment, the oligomeric PET substrate comprises a hydroxyl end group:carboxyl end group ratio of from 2.22 to 4.0, a Dp of from 25 to 35, and a CEG of from 80 to 150 mol acid ends/te of material.

The source of the benefit associated with the optimised end group ratio is found in the balance of the reaction rates for esterification over polycondensation, the relative partial pressures of the condensation products, i.e. of water and ethylene glycol, and the balance of the chemical equilibrium constants of esterification as compared with polycondensation. This balance results in a natural optimum in the range from 2.22 to 4.0 as specified earlier.

In one non-limiting embodiment, the PTA is added to the rBHET in a range from 10 wt % to 60 wt %, and preferably in the range 30 wt % to 36 wt % with respect to PET polymer.

In another non-limiting embodiment, the PTA is added to the higher molecular weight oligomer derived from rBHET in a range from 0.5 wt % to 5 wt %, and preferably in the range 1 wt % to 2 wt % with respect to PET polymer.

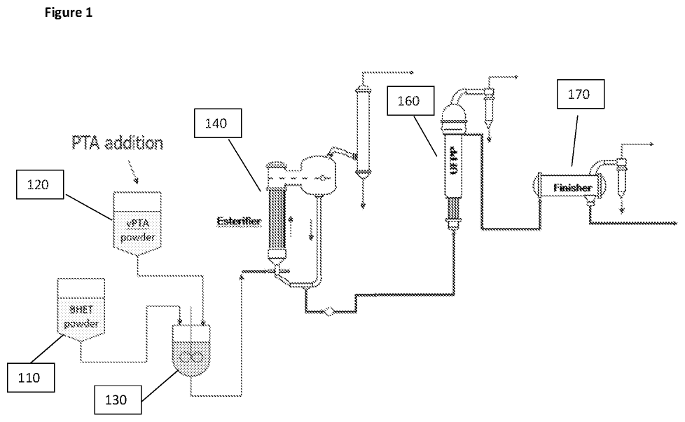

In one non-limiting embodiment, PTA powder is mixed with the molten rBHET to form a slurry before this slurry is added to a reaction zone. In one non-limiting embodiment, this reaction zone is an area of the plant with sufficient residence time and appropriate temperature to complete the desired esterification reaction, for example, Esterifier 140 as shown in FIG. 1.

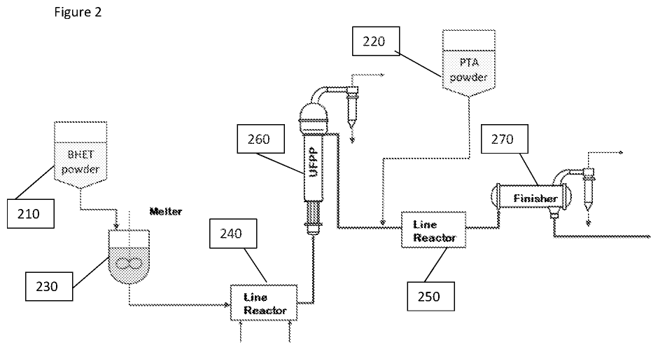

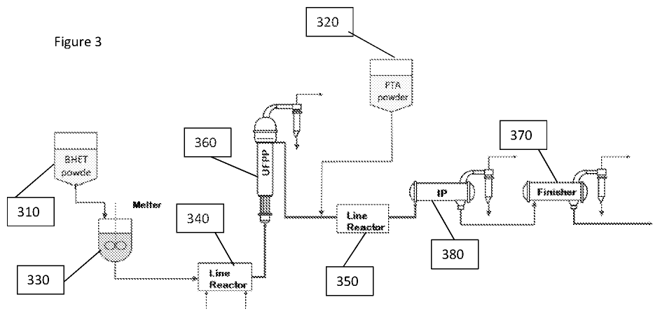

In one non-limiting embodiment, the PTA powder is mixed with a molten higher molecular weight oligomer derived from rBHET and passed to a reaction zone. In one non-limiting embodiment, this reaction zone is an area of the plant with sufficient residence time and appropriate temperature to complete the desired esterification reaction, for example, a post-UFPP line reactor 250 and 350 as shown respectively in FIGS. 2 and 3.

In one non-limiting embodiment, the rBHET is reacted with PTA at a temperature from 120° C. to 300° C., and preferably from 150° C. to 270° C.

In another non-limiting embodiment, the higher molecular weight oligomer derived from rBHET is reacted with PTA at a temperature from 270° C. to 300° C., preferably from 285° C. to 295° C.

The residence time in the reaction zone may be from 30 minutes to 120 minutes, and preferably from 40 to 50 minutes.

In one non-limiting embodiment, the rBHET or higher molecular weight oligomer derived from rBHET is reacted with PTA at a pressure from 3 barg to 30 barg. This pressure is created in the reaction zone.

The reaction between the rBHET or higher molecular weight rBHET oligomer and PTA may be catalysed or uncatalyzed, depending on the composition of the PCR-flake that was used to make the rBHET. In one non-limiting embodiment, the rBHET or higher molecular weight rBHET oligomer and PTA are reacted with an exogenously added catalyst. A post-consumer PET-containing waste material or PCR-flake may comprise latent catalyst because the waste PET contains catalyst as a result of its manufacturing process. Therefore, in some embodiments the rBHET derived from PCR flake may have sufficient endogenous catalyst. Nevertheless, additional exogenous catalyst may still be added where necessary. Non-limiting examples of catalysts that may be added to the reaction zone include catalysts comprising antimony, titanium, zinc, manganese, germanium, aluminium and tin. These may be selected from an antimony-containing catalyst, a titanium-containing catalyst, a zinc-containing catalyst, an acetate-containing catalyst, a manganese-containing catalyst, a germanium-containing catalyst, an aluminium-containing catalyst or a tin-containing catalyst. These may be, for example, antimony trioxide, antimony glycolate, antimony triacetate, titanium alkoxide, zinc acetate and/or manganese acetate. Such catalysts are added to the reaction zone typically known as the esterification unit or zone. A titanium-containing catalyst is typically added at 2-100 ppm, and preferably around 10 ppm. All other catalysts (except a titanium-containing catalyst) is typically added at 40-300 ppm, preferably around 240 ppm, with regard to final PET polymer.

In an embodiment, the rPET manufacturing process is a conventional rPET manufacturing process or a modified vPET manufacturing process. In either process, the rBHET may be fed directly or indirectly into said rPET manufacturing process.

In some non-limiting embodiments, the oligomeric PET substrate is used in a rPET manufacturing process, which was previously designed to synthesise vPET but which has been retrofitted to make rPET. In an alternative non-limiting embodiment, the oligomeric PET substrate is used in a rPET manufacturing process that was specifically designed from the outset to make rPET.

An aspect of the present disclosure also relates to oligomeric PET substrate produced by or obtainable by a method as described herein. In one non-limiting embodiment, the present disclosure relates to oligomeric PET substrate produced by using rBHET derived from PCR-flake.

In some embodiments, the oligomeric PET substrate has a structure according to Formula I:

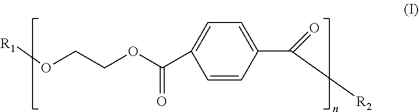

wherein R1 is a carboxyl end group or a hydroxyl end group, R2 is a carboxyl end group or a hydroxyl end group, and n is a degree of polymerisation, and wherein the oligomeric PET substrate is represented by two or more of the following characteristics:
i) n is a degree of polymerisation of 1 to 10;
ii) a CEG (mols acid ends/te of material) of from 300 to 1500; and
iii) a hydroxyl end group/carboxyl end group ratio in the range of 1.66 to 6.66.

In some embodiments, the oligomeric PET substrate is represented by the following characteristics: (i) n is a degree of polymerisation of 1 to 10 and (ii) a CEG (mols acid ends/te of material) of from 300 to 1500. In some embodiments, the oligomeric PET substrate is represented by the following characteristics: (i) n is a degree of polymerisation of 3 to 7 and (ii) a CEG (mols acid ends/te of material) of from 700 to 1100.

In some embodiments, the oligomeric PET substrate has a structure according to Formula I:

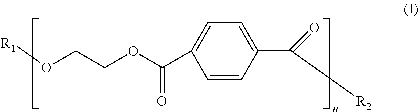

wherein R1 is a carboxyl end group or a hydroxyl end group, R2 is a carboxyl end group or a hydroxyl end group, and n is a degree of polymerisation, and wherein the oligomeric PET substrate is represented by two or more of the following characteristics:
i) n is a degree of polymerisation of 20 to 50;
ii) a CEG (mols acid ends/te of material) of from 40 to 200; and
iii) a hydroxyl end group/carboxyl end group ratio in the range of 1.66 to 6.66.

In some embodiments, the oligomeric PET substrate is represented by the following characteristics: (i) n is a degree of polymerisation of 20 to 50 and (ii) a CEG (mols acid ends/te of material) of from 40 to 200. In some embodiments, the oligomeric PET substrate is represented by the following characteristics: (i) n is a degree of polymerisation of 25 to 35 and (ii) a CEG (mols acid ends/te of material) of from 80 to 150.

A further aspect of the present disclosure also relates to PET polymer manufactured in a polymerisation process using oligomeric PET substrate produced by or obtainable by a method as described herein. The PET polymer may comprise 5-100% rPET. Therefore, the PET polymer may comprise a mixture of vPET and rPET.

Referring to FIG. 1, a process 100 according to one aspect of the present disclosure is shown for the production of an oligomeric PET substrate from a rBHET powder stored in a hopper 110 and PTA stored in a hopper 120. In the process shown, the rBHET in a molten form and PTA powders are fed from their respective hoppers 110, 120 to a mixing vessel 130, and the resultant slurry is stirred before being fed to an esterifier 140. The esterifier 140 is maintained under conditions such that the rBHET reacts with the PTA to produce an oligomeric PET substrate. The effluent from the esterifier zone 140 is fed to a pre-polymeriser vessel 160 and then to a finisher vessel 170 to increase a degree of polymerisation of the monomer.

Referring to FIG. 2, a process 200 according to one aspect of the present disclosure is shown for the production of an oligomeric PET substrate from a rBHET powder stored in a hopper 210 and PTA stored in a hopper 220. In the process shown, the rBHET from hopper 210 is fed via melter 230 and line reactor 240 to a pre-polymerisation vessel (UFPP) 260 thereby forming a higher molecular weight oligomer derived from rBHET, after which PTA from hopper 220 is added. Line reactor 250 is maintained under conditions such that the higher molecular weight oligomer derived from rBHET reacts with the PTA to produce an oligomeric PET substrate. The effluent from line reactor 250 is then fed to a finisher vessel 270 to increase a degree of polymerisation of the monomer.

Referring to FIG. 3, a process 300 according to one aspect of the present disclosure is shown for the production of an oligomeric PET substrate from a rBHET powder stored in a hopper 310 and PTA stored in a hopper 320. In the process shown, the rBHET from hopper 310 is fed via melter 330 and line reactor 340 to a pre-polymerisation vessel (UFPP) 360 thereby forming a higher molecular weight oligomer derived from rBHET, after which PTA from hopper 320 is added. Line reactor 350 is maintained under conditions such that the higher molecular weight oligomer derived from rBHET reacts with the PTA to produce an oligomeric PET substrate. The effluent from line reactor 350 is then fed to an intermediate polymeriser (IP) 380 and then to a finisher vessel 370 to increase a degree of polymerisation of the monomer.

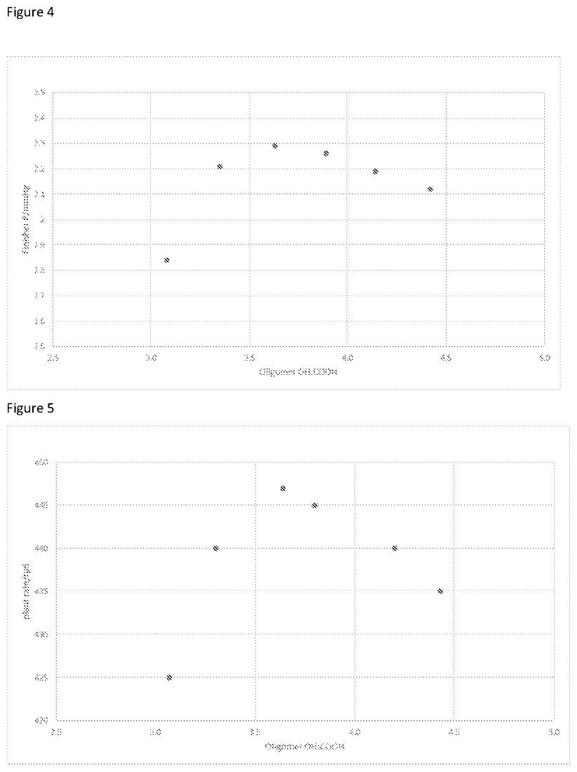

The PET polymers and methods of the disclosure will now be more particularly described with reference to the following non-limiting Examples and FIGS. 4 to 7 of the accompanying drawings.

### EXAMPLES

Aspects of the disclosure are demonstrated by process modelling examples of a commercial scale continuous polymerisation (CP) operation which illustrate the predicted impact of addition rates of PTA to bis-hydroxyethylene terephthalate (BHET).

Separately the methods of the disclosure have also been demonstrated on a 20 L (litre) semi-works scale batch reactor using the following experimental protocol.

Typically, either 8 kg of PTA-based oligomer or 10.58 kg of BHET were charged to a reactor under ambient conditions along with sufficient antimony trioxide catalyst to achieve 280 ppm Sb (as element), cobalt acetate tetrahydrate to achieve 40 ppm Co (as element), and triethyl phosphate to achieve 20 ppm P (as element). As per the detailed examples below other additives were added as described. The reactor was then isolated under a nitrogen blanket and heat applied. The reactor temperature set-point was then set to 260° C., and as the content's temperature increased, the reactor pressure rose naturally as a consequence of the vapour pressure of the water and ethylene glycol. During this time and throughout this initial period, the contents were agitated at 50-120 rpm. Once 260° C. had been established, the reactor was held for the pre-determined time, typically 30 to 60 minutes, before the pressure was released to atmospheric pressure and an oligomeric liquid sample taken. The vapours released during the pressure let down were condensed and collected in a receiving vessel. Once the oligomeric sample had been collected, vacuum was applied to the reactor stepwise from 1000 millibar absolute (mbara) to full vacuum, typically less than 2 mbara, in 250 mbara steps with 15 minutes per step. At the same time the reactor temperature set-point was raised to 290° C. The reactor temperature set-point was achieved by the end of the vacuum let down, typically after 60 minutes. The following period is referred to as the polycondensation time when the contents are held at 290° C., under full vacuum and agitated at 100 rpm. These conditions were maintained until the agitator torque reached a predetermined value of 15 Nm, associated with an intrinsic viscosity (iV) of 0.54 deciliter/gram (dl/g) at which point the vacuum was released and the agitator stopped to degas the resulting polymer. Throughout the volatiles were condensed and collected as before. When degassing was complete, typically after 10 minutes, the molten polymer was discharged by 2 barg overpressure and pelletised via a cooling trough.

The resulting polymer was then subjected to various standard PET analytical procedures including iV, carboxyl end group analysis (COOH), diethylene glycol analysis (DEG), CIE color analysis and X-ray fluorescence (XRF) analysis for metals content.

### Comparative Example 1

| Parameter | Value | Units |
|---|---|---|
| BHET | 8.0 | kg |
| H2O | 0.0 | kg |
| PTA | 0.0 | kg |
| CoAc•4H2O | 1.36 | g |
| TEP | 0.94 | g |
| Oligomer hold | | |
| Temp | 250 | ° C. |
| Pressure | 1.9 | barg |
| time | 40 | mins |
| Oligomer COOH | 40.7 | microeq/g |
| Polymerisation | | |
| Temp | 290 | ° C. |
| Pressure | 1.5 | mbara |
| time | 75 | mins |
| iV | 0.549 | dl/g |
| COOH | 30.7 | microeq/g |
| Sb | 361 | ppm |
| P | 15.7 | ppm |
| Co | 49.2 | ppm |
| L* color | 45.61 | CIE |
| B* color | 11.5 | CIE |

As shown in the above table, in Example 1 8.0 kg of rPET sourced BHET was polymerised at 290° C. As can be seen in the table above the polymer made had a COOH value of 30.7 microequivalents/g, an iV of 0.549 dl/g, an L color of 45.61 and a b color of 11.5. The oligomer COOH number quoted in the table is for the starting material. The polymerisation time was 75 minutes.

### Comparative Example 2

| Parameter | Value | Units |
|---|---|---|
| PTA oligomer | 8.0 | kg |
| H2O | 0.0 | kg |
| PTA | 0.0 | kg |
| CoAc•4H2O | 1.36 | g |
| TEP | 0.94 | g |
| Oligomer hold | | |
| Temp | 250 | ° C. |
| Pressure | 2.8 | barg |
| time | 50 | mins |
| Oligomer COOH | 924 | microeq/g |
| Polymerisation | | |
| Temp | 290 | ° C. |
| Pressure | 1.8 | mbara |
| time | 95 | mins |
| iV | 0.541 | dl/g |
| COOH | 26.4 | microeq/g |
| Sb | 274 | ppm |
| P | 55 | ppm |
| Co | 39 | ppm |
| L* color | 63.99 | CIE |
| B* color | 9.89 | CIE |

As shown in the above table, in Example 2, 8.0 kg of commercial-scale PTA-based oligomer was polymerised at 290° C. As can be seen in the table the polymer made had a COOH value of 26.4 microequivalents/g, an iV of 0.541 dl/g, an L color of 63.99 and a b color of 9.89. The oligomer COOH number quoted in the table is for the starting material. The polymerisation time was 95 minutes.

### Comparative Example 3

| Parameter | Value | Units |
|---|---|---|
| PTA | 6.92 | kg |
| EG | 3.62 | kg |
| H2O | 0.0 | kg |
| PTA | 0.0 | kg |
| CoAc•4H2O | 1.36 | g |
| TEP | 0.94 | g |
| Oligomer hold | | |
| Temp | 250 | ° C. |
| Pressure | 1.9 | barg |
| time | 40 | mins |
| Oligomer COOH | | microeq/g |
| Polymerisation | | |
| Temp | 290 | ° C. |
| Pressure | 1.5 | mbara |
| time | 75 | mins |
| iV | 0.535 | dl/g |
| COOH | 30.9 | microeq/g |
| Sb | 211 | ppm |
| P | 11 | ppm |
| Co | 27.5 | ppm |
| L* color | 59.45 | CIE |
| B* color | 12.56 | CIE |

As shown in the above table, in Example 3, 6.92 kg of vPTA was reacted with 3.62 kg of ethylene glycol at 246° C. for nine hours. The pressure of the sealed autoclave was allowed to rise naturally as esterification took place but was vented periodically from 9 barg down to 4 barg to allow the release of water. When no further pressure rise was observed, i.e., esterification was complete, the vessel was allowed to cool and the additives charged as in the previous examples. The resulting oligomer was then polymerised at 290° C. As can be seen in the table the polymer made had a COOH value of 30.9 microequivalents/g, an iV of 0.535 dl/g, an L* color of 59.45 and a b* color of 12.56. No oligomer COOH number is available for this example. The polymerisation time was 75 minutes.

### Example 4

| Parameter | Value | Units |
|---|---|---|
| BHET | 7.97 | kg |
| H2O | 0.0 | kg |
| PTA | 2.61 | kg |
| CoAc•4H2O | 40 | ppm |
| TEP | 20 | ppm |
| Oligomer COOH | 471 | microeq/g |
| Oligomer hold | | |
| Temp | 260 | ° C. |
| Pressure | 8.5 | barg |
| time | 90 | mins |
| Polymerisation | | |
| Temp | 290 | C. |
| Pressure | 1.6 | mBara |
| time | 70 | mins |
| iV | 0.506 | dl/g |
| COOH | 23.4 | microeq/g |
| Sb | 344 | ppm |
| P | 11.3 | ppm |
| Co | 32.6 | ppm |
| L* color | 49.75 | CIE |
| B* color | 8.97 | CIE |

As shown in the above table, in Example 4, 2.61 kg of vPTA was added to 7.97 kg of rPET sourced BHET and held at 260° C. for 90 mins before being polymerised at 290° C. As can be seen in the table the polymer made had a COOH value of 23.4 microequivalents/g, an iV of 0.506 dl/g, an L* color of 49.75 and a b* color of 8.97. The oligomer COOH number of 471 microquivalents/g is significantly higher than that of the starting material indicative of esterification having taken place. The polymerisation time was 70 minutes.

### Comparative Example 5

The following and subsequent examples take the form of a process model simulations of a three vessel CP process operating at 450 tonnes per day making a typical bottle resin grade PET. The reactor train comprises an Esterifier, a pre-polymerisation vessel (UFPP) and a Finisher vessel. The process conditions used for the simulation are described below:

| Parameter | Value | Units |
|---|---|---|
| Esterifier | | |
| Feed mole ratio | 1.89 | moles EG:moles TA |
| Temperature | 270 | ° C. |
| Pressure | 0.1 | barg |
| Residence time | 199 | mins |
| Additives zone | | |
| Sb | 280 | ppm |
| P | 20 | ppm |
| Co | 40 | ppm |
| EG | 200 | kg/hr |
| Oligomer COOH | 815 | microeq/g |
| Oligomer OH/COOH | 3.63 | |
| UFPP | | |
| Temperature | 294 | ° C. |
| Pressure | 20 | mmHg |
| Residence time | 27.9 | mins |
| Finisher | | |
| Temperature | 293 | ° C. |
| Pressure | 2.29 | mmHg |
| Residence time | 49.5 | mins |
| iV | 0.56 | dl/g |
| COOH | 43.0 | microeq/g |
| L* color | 67.3 | CIE |
| B* color | −0.61 | CIE |

The key parameters of interest are the oligomer OH:COOH value of 3.63 and the 2.29 mmHga finisher pressure. Within the simulation as the Esterifier feed mole ratio is increased the effect is to alter the oligomer OH:COOH upwards and this impacts the reactivity and hence the predicted Finisher vacuum requirement. This predicted effect is shown in the FIG. 4.

An alternative way to represent this is to simulate the plant rate, or plant capacity as function of oligomer OH:COOH whilst maintaining a constant Finisher vacuum. This is shown in the FIG. 5, from which it will be seen that a change in oligomer OH:COOH from about 3.1 to about 3.6 is equivalent to about 5% in plant capacity.

### Comparative Example 6

The following is a predicted example of the same three vessel CP process as in Example 5, operating at 450 tonnes per day making the same typical bottle resin grade PET, but this time with a BHET feed.

| Parameter | Value | Units |
|---|---|---|
| Additives zone | | |
| BHET | 24800 | kg/hr |
| Sb | 280 | ppm |
| P | 20 | ppm |
| Co | 40 | ppm |
| EG | 0 | kg/hr |
| Oligomer COOH | 17 | microeq/g |
| Oligomer OH/COOH | 508 | |
| UFPP | | |
| Temperature | 294 | ° C. |
| Pressure | 20 | mmHg |
| Residence time | 27.9 | mins |
| Finisher | | |
| Temperature | 293 | ° C. |
| Pressure | 1.58 | mmHg |
| Residence time | 49.5 | mins |
| iV | 0.56 | dl/g |
| COOH | 14.0 | microeq/g |
| L* color | 59.2 | CIE |
| B* color | −1.76 | CIE |

The key parameters of interest are the very high (508) oligomer OH:COOH and the much reduced 1.58 mmHg finisher pressure requirement. This oligomer OH:COOH is so large as to be off the chart above for capacity and in this case to raise the Finisher pressure to 2.3 mmHg, as in Example 5, the plant rate must be dropped to 390 tpd, representing a capacity reduction of some 20%. The deterioration in L* color is also significant.

### Example 7

Holding all the parameters in Example 6 constant and adding varying amounts of PTA to BHET whilst maintaining 450 tonnes per day of PET, the following set of results were obtained:

| vPTA | % vPTA | | | | | |
|---|---|---|---|---|---|---|
| added/ | (PET | BHET/ | Oligomer | Oligomer | Finisher COOH/ | Finisher P/ |
| kgph | basis) | kgph | COOH | OH:COOH | microeq/g | mmHg |
| 0 | 0 | 24805 | 17 | 508 | 14.0 | 1.58 |
| 811 | 5 | 23564 | 230 | 35.4 | 14.5 | 1.61 |
| 1621 | 10 | 22324 | 411 | 18.7 | 16.4 | 1.73 |
| 2432 | 15 | 21084 | 602 | 12.0 | 22.6 | 2.00 |
| 3242 | 20 | 19844 | 816 | 8.29 | 40.6 | 2.40 |
| 3729 | 23 | 19100 | 958 | 6.76 | 65.2 | 1.92 |

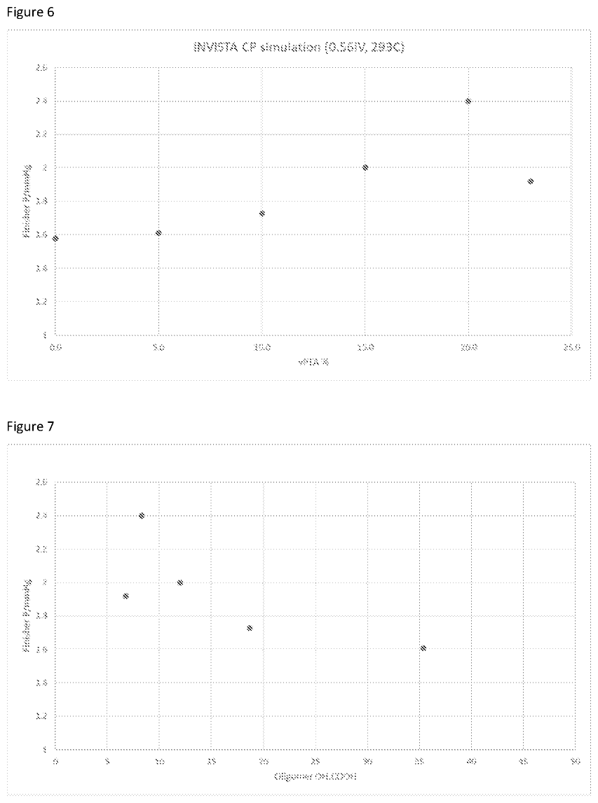

The above results are also shown graphically as Finisher pressure required against % vPTA added in FIG. 6.

A clear optimum is seen at around 18% vPTA as represented by a maximum in the predicted Finisher vacuum requirement. This is also shown graphically as Finisher vacuum requirement against oligomer OH:COOH in FIG. 7.

An optimum oligomer OH:COOH of around 10:1 can be seen from FIG. 7. Clearly, based on the improvement in Finisher vacuum requirement, the operation of the plant can be restored to the full 450 tonnes per day with around 18% vPTA added to the process.

### Example 8

Examples 8 and 9 are process model simulations of a three vessel CP process operating at 450 tonnes per day making a typical bottle resin grade PET with a BHET feed and a line reactor inserted between the UFPP and Finisher vessels. The process conditions used for the simulation are described below:

| Parameter | Value | Units |
|---|---|---|
| Additives zone | | |
| BHET | 24800 | kg/hr |
| Sb | 280 | ppm |
| P | 20 | ppm |
| Co | 40 | ppm |
| EG | 0 | kg/hr |
| Oligomer COOH | 16 | microeq/g |
| Oligomer OH/COOH | 556 | |
| UFPP | | |
| Temperature | 294 | ° C. |
| Pressure | 20 | mmHg |
| Residence time | 28.9 | mins |
| Line Reactor | | |
| PTA | 0 | kg/hr |
| LR oligomer COOH | 15.8 | microeq/g |
| LR oligomer OH/COOH | 28.9 | |
| LI oligomer iV | 0.189 | dl/g |
| Finisher | | |
| Temperature | 293 | ° C. |
| Pressure | 1.50 | mmHg |
| Residence time | 49.5 | mins |
| iV | 0.56 | dl/g |
| COOH | 15.9 | microeq/g |
| L | 58.8 | CIE |
| b | −2.91 | CIE |

The key parameters of interest are the line reactor oligomer OH:COOH value of 28.9 microeq/g, the line reactor oligomer iV of 0.189 dl/g and the 1.50 mmHg finisher pressure.

### Example 9

In Example 9 200 kg/hr of PTA (1.1 wt % based on PET) is added to the post-UFPP line reactor.

| Parameter | Value | Units |
|---|---|---|
| Additives zone | | |
| BHET | 24800 | kg/hr |
| Sb | 280 | ppm |
| P | 20 | ppm |
| Co | 40 | ppm |
| EG | 0 | kg/hr |
| Oligomer COOH | 16 | microeq/g |
| Oligomer OH/COOH | 556 | |
| UFPP | | |
| Temperature | 294 | ° C. |
| Pressure | 20 | mmHg |
| Residence time | 28.9 | mins |
| Line Reactor | | |
| PTA | 200 | kg/hr |
| LR oligomer COOH | 129 | microeq/g |
| LR oligomer OH/COOH | 3.4 | |
| LR oligomer iV | 0.161 | dl/g |
| Finisher | | |
| Temperature | 293 | ° C. |
| Pressure | 1.27 | mmHg |
| Residence time | 49.5 | mins |
| iV | 0.56 | dl/g |
| COOH | 47.6 | microeq/g |
| L | 58.8 | CIE |
| b | −2.96 | CIE |

The line reactor oligomer OH:COOH value decreases to 3.4 and the Finisher pressure fall slightly to 1.27 mmHg. So, even though the addition of PTA has improved the line reactor OH:COOH the esterification reaction has liberated water and reduced the iV to 0.161 dl/g meaning the Finisher has to work a little harder to maintain productivity. Note that the wt % PTA required to reach the desired OH:COOH is much lower than Example 7; a consequence of the higher molecular weight line reactor oligomer.

### Example 10

Examples 10 and 11 are process model simulations of a four vessel CP process operating at 450 tonnes per day making a typical bottle resin grade PET with a BHET feed, a line reactor inserted after the UFPP, an Intermediate Polymeriser (IP) and a Finisher vessel. The process conditions used for the simulation are described below:

| Parameter | Value | Units |
|---|---|---|
| Additives zone | | |
| BHET | 24800 | kg/hr |
| Sb | 280 | ppm |
| P | 20 | ppm |
| Co | 40 | ppm |
| EG | 0 | kg/hr |
| Oligomer COOH | 16 | microeq/g |
| Oligomer OH/COOH | 556 | |
| UFPP | | |
| Temperature | 294 | ° C. |
| Pressure | 20 | mmHg |
| Residence time | 28.9 | mins |
| Line Reactor | | |
| PTA | 0 | kg/hr |
| LR oligomer COOH | 15.8 | microeq/g |
| LR oligomer OH/COOH | 28.9 | |
| LI oligomer iV | 0.189 | dl/g |
| Intermediate Polymeriser | | |
| Temperature | 285 | ° C. |
| Pressure | 5.81 | mmHg |
| Residence time | 41.7 | mins |
| iV target | 0.4 | Dl/g |
| Finisher | | |
| Temperature | 286 | ° C. |
| Pressure | 2.36 | mmHg |
| Residence time | 48.0 | mins |
| iV | 0.56 | dl/g |
| COOH | 17.0 | microeq/g |
| L | 58.8 | CIE |
| b | −2.4 | CIE |

The key parameters of interest are the line reactor oligomer OH:COOH value of 28.9 as in Example 8, the line reactor oligomer iV of 0.189 dl/g, the 5.81 mmHg IP vacuum level and the 2.36 mmHg finisher pressure.

### Example 11

In Example 11 200 kg/hr of PTA is added to the post-UFPP line reactor.

| Parameter | Value | Units |
|---|---|---|
| Additives zone | | |
| BHET | 24800 | kg/hr |
| Sb | 280 | ppm |
| P | 20 | ppm |
| Co | 40 | ppm |
| EG | 0 | kg/hr |
| Oligomer COOH | 16 | microeq/g |
| Oligomer OH/COOH | 556 | |
| UFPP | | |
| Temperature | 294 | ° C. |
| Pressure | 20 | mmHg |
| Residence time | 28.9 | mins |
| Line Reactor | | |
| PTA | 200 | kg/hr |
| LR oligomer COOH | 129 | microeq/g |
| LR oligomer OH/COOH | 3.40 | |
| LI oligomer iV | 0.161 | dl/g |
| Intermediate Polymeriser | | |
| Temperature | 285 | ° C. |
| Pressure | 7.82 | mmHg |
| Residence time | 37.9 | mins |
| iV target | 0.4 | dl/g |
| Finisher | | |
| Temperature | 293 | ° C. |
| Pressure | 2.91 | mmHg |
| Residence time | 47.9 | mins |
| iV | 0.56 | dl/g |
| COOH | 43 | microeq/g |
| L | 58.8 | CIE |
| b | −2.96 | CIE |

The line reactor oligomer OH:COOH value decreases to 3.4 as in Example 9 but this time the Finisher pressure increases to 2.91 mmHg. The addition of PTA has improved the line reactor OH:COOH but this time the use of an IP has enabled the Finisher to take full advantage of the improved reactivity. Once again it is noted that the wt % PTA required to reach the desired OH:COOH is much lower than Example 7; a consequence of the higher molecular weight line reactor oligomer.

1. A method for producing an oligomeric PET substrate for use in a rPET manufacturing process, the method comprising:
reacting recycled bis-hydroxylethyleneterephthalate (rBHET) or a higher molecular weight oligomer derived from rBHET, with purified terephthalic acid (PTA) to produce an oligomeric PET substrate represented by Formula I: 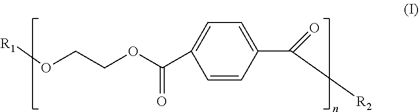
wherein R1 is a carboxyl end group or a hydroxyl end group, R2 is a carboxyl end group or a hydroxyl end group, and n is a degree of polymerisation.

2. The method according to claim 1, wherein when the method comprises reacting rBHET with PTA the n is 1 to 10, preferably 3 to 7 and wherein when the method comprises reacting a higher molecular weight oligomer derived from rBHET with PTA, the n is 20 to 50, preferably 25 to 35.

3. The method according to claim 1, further comprising reacting rBHET with PTA, the oligomeric PET substrate has a CEG (mols acid ends/te of material) of from 300 to 1500, preferably from 500 to 1200, more preferably from 700 to 1100 and wherein when the method comprises reacting a higher molecular weight oligomer derived from rBHET with PTA, the oligomeric PET substrate has a CEG (mols acid ends/te of material) of from 40 to 200, preferably from 80 to 150.

4. The method according to claim 1, wherein the oligomeric PET substrate has a hydroxyl end group: carboxyl end group ratio in the range of 1.66 to 6.66, preferably in the range of 2.22 to 4.0.

5. The method according to claim 1, wherein when the method comprises reacting rBHET with PTA, the PTA is added to the rBHET in an amount in the range from 10 wt % to 60 wt %, preferably from 30 wt % to 36 wt % with respect to PET polymer and wherein when the method comprises reacting a higher molecular weight oligomer derived from rBHET with PTA, the PTA is added to the rBHET in an amount in the range from 0.5 wt % to 5 wt %, preferably from 1 wt % to 2 wt % with respect to PET polymer.

6. The method according to claim 1, wherein the rBHET or a higher molecular weight oligomer derived from rBHET is mixed with the PTA prior to addition to a reaction zone.

7. The method according to claim 6, wherein the rBHET is reacted with the PTA at a temperature from 120° C. to 300° C., preferably from 150° C. to 270° C. and the higher molecular weight oligomer derived from rBHET is reacted with PTA at a temperature from 270° C. to 300° C., preferably from 285° C. to 295° C.

8. The method according to claim 6, comprising a residence time in the reaction zone of from 30 minutes to 120 minutes, preferably from 40 minutes to 50 minutes.

9. The method according to claim 1, wherein the rBHET or higher molecular weight oligomer derived from rBHET is reacted with the PTA at a pressure between 3 barg and 30 barg.

10. The method according to claim 9, wherein the rBHET or higher molecular weight oligomer derived from rBHET is reacted with the PTA using an exogenously added catalyst selected from an antimony-containing catalyst, titanium-containing catalyst, a zinc-containing catalyst, an acetate-containing catalyst, a manganese-containing catalyst, a germanium-containing catalyst, an aluminium-containing catalyst, a tin-containing catalyst and mixtures thereof.

11. The method according to claim 10, wherein the catalyst is any one of antimony trioxide, antimony glycolate, antimony triacetate, titanium alkoxide, zinc acetate or manganese acetate.

12. The method according to claim 1, wherein the oligomeric PET substrate is fed directly or indirectly into a rPET manufacturing process.

13. An oligomeric PET substrate produced by the method of claim 1, wherein said oligomeric PET substrate has the following structure 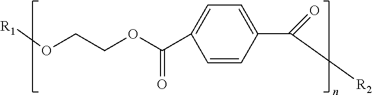
and further comprises any two of the following characteristics:
i) n is a degree of polymerisation of 1-10;
ii) a CEG (mols acid ends/to of material) of from 300 to 1500; and
iii) a hydroxyl end group/carboxyl end group ratio in the range of 1.66 to 6.66.

14. An oligomeric PET substrate produced by the method of claim 1, wherein the oligomeric PET substrate has the following structure 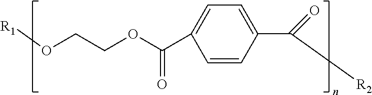
and further comprises any two of the following characteristics:
i) n is a degree of polymerisation of 20 to 50;
ii) a CEG (mols acid ends/to of material) of from 40 to 200; and
iii) a hydroxyl end group/carboxyl end group ratio in the range of 1.66 to 6.66.

15. A PET polymer comprising 5-100% rPET produced from the oligomeric PET substrate as claimed in claim 13.

16. A PET polymer comprising 5-100% rPET produced from the oligomeric PET substrate as claimed in claim 14.

17. The method according to claim 1, comprising a residence time in a reaction zone of from 30 minutes to 120 minutes, preferably from 40 minutes to 50 minutes.

18. The method according to claim 1, wherein the rBHET or higher molecular weight oligomer derived from rBHET is reacted with the PTA using an exogenously added catalyst selected from an antimony-containing catalyst, titanium-containing catalyst, a zinc-containing catalyst, an acetate-containing catalyst, a manganese-containing catalyst, a germanium-containing catalyst, an aluminium-containing catalyst, a tin-containing catalyst and mixtures thereof.

19. The method according to claim 13, wherein the oligomeric PET substrate is fed directly or indirectly into a rPET manufacturing process.

20. The method according to claim 14, wherein the oligomeric PET substrate is fed directly or indirectly into a rPET manufacturing process.
